(19) United States
(12) Patent Application Publication
(10) Pub. No.: US 2014/0225709 A1
(43) Pub. Date: Aug. 14, 2014

(54) TEMPERATURE-DEPENDENT SWITCH

(71) Applicant: Thermik Geraetebau GmbH, Sondershausen (DE)

(72) Inventors: Michael KIRCH, Sondershausen (DE); Elfriede KLASCHEWSKI, Guenstedt (DE); René NEUMANN, Badra (DE)

(21) Appl. No.: 14/182,440

(22) Filed: Feb. 18, 2014

(30) Foreign Application Priority Data
Feb. 13, 2013 (DE) 10 2013 101 392

(51) Int. Cl. H01H 37/72

(52) U.S. Cl. CPC H01H 37/72
USPC 337/365

(57) ABSTRACT

A temperature-dependent switch has a first and a second stationary counter contact and a temperature-dependent switching mechanism comprising a temperature-dependent snap-action disc bearing a contact element and having a geometric high-temperature configuration and a geometric low-temperature configuration, and a bi-stable spring disc with two geometric configurations with temperature-independent stability. The switching mechanism produces an electrically conductive connection between the two counter contacts via the contact element. The spring disc presses the contact element either against the first counter contact or keeps it spaced apart therefrom. The snap-action disc is supported with its rim on the switch during the switching and in the process the spring disc flips from its first stable configuration into its second stable configuration, in which it remains even when the snap-action disc flips back. The snap-action disc is fixed on the contact element, and a clearance is provided for the rim of the snap-action disc.

### CROSS-REFERENCE TO RELATED APPLICATIONS

This application claims priority to German patent application DE 10 2013 101 392, filed Feb. 13, 2013. This priority application is incorporated herein by reference.

### BACKGROUND OF THE INVENTION

The present invention relates to a temperature-dependent switch, which switch has a first and a second stationary counter contact and a temperature-dependent switching mechanism, which switching mechanism comprises a contact element, a temperature-dependent snap-action disc with a geometric high-temperature configuration and a geometric low-temperature configuration and a bi-stable spring disc with two geometric configurations with temperature-independent stability, which bi-stable spring disc bears the contact element, wherein the switching mechanism in one of its switching positions produces an electrically conductive connection between the two counter contacts via the contact element, wherein the spring disc in its first configuration presses the contact element against the first counter contact and in its second configuration keeps the contact element spaced apart from the first counter contact, wherein the snap-action disc is supported with its rim on a part of the switch during the transition from the low-temperature configuration of said snap-action disc to its high-temperature configuration and in the process acts on the spring disc in such a way that said spring disc flips over from its first stable configuration to its second stable configuration, in which second stable configuration it remains even when the snap-action disc flips back from its high-temperature configuration to its low-temperature configuration.

Such a switch is known from DE 10 2007 042 188 B3.

The known switch has three switching positions. In its low-temperature position, the switch is closed, with the result that the two counter contacts are electrically connected to one another.

In its high-temperature position, the switch is open, with the result that no current can flow through the switch. In its cooling position, the switch continues to remain open although the snap-action disc has cooled again and has therefore assumed its low-temperature configuration again.

In this way, the temperature-dependent switch is a single-use switch which remains open after having been opened once even when the temperature of the snap-action disc has decreased again.

Comparable single-use switches are known from DE 86 25 999 U1 and DE 25 44 201 A.

Such temperature-dependent switches are used in a known manner for protecting electrical devices from overheating. For this purpose, the switch is connected electrically in series with the device to be protected and the AC supply voltage thereof and is arranged mechanically on the device in such a way that it is thermally connected thereto.

Below the response temperature of the snap-action disc, the two counter contacts are electrically connected to one another, with the result that the circuit is closed and the load current of the device to be protected flows via the switch. If the temperature increases to beyond a permissible value, the snap-action disc lifts off the contact element from the counter contact against the actuating force of the spring disc, as a result of which the switch is opened and the load current of the device to be protected is interrupted.

The now de-energized device can cool down again. In the process, the switch which is thermally coupled to the device also cools down again, and the switch would thereupon actually automatically close again.

In the case of the three above-mentioned switches, provision is now made for this switching back in the cooling position not to take place, with the result that the device to be protected cannot automatically switch on again once it has been switched off. This is a safety function which is intended to avoid damage, as is applicable for electric motors which are used as drive assemblies, for example.

It is also known to provide such temperature-dependent switches with a so-called self-holding resistor, which is connected in parallel with the two counter contacts such that it takes up some of the load current when the switch opens. Ohmic heat is then generated in this self-holding resistor which is sufficient for keeping the snap-action disc above its response temperature.

However, this self-holding is only active for as long as the electrical device is still switched on. As soon as the device is disconnected from the supply circuit, no current flows through the temperature-dependent switch any more either, with the result that the self-holding function is no longer available.

After re-connection of the electrical device, the switch would again be in the closed state, with the result that the device can heat up again, which could result in consequential damage.

This problem is avoided with the generic temperature-dependent switch in which the self-holding function is not implemented electrically but mechanically by a bi-stable spring part, which spring part has independent of temperature two stable geometric configurations, as described in the three above-cited documents.

In contrast to this, the snap-action disc is a bi-stable snap-action disc which depending on temperature assumes either a high-temperature configuration or a low-temperature configuration.

In DE 10 2007 042 188 B3 mentioned at the outset, the spring disc is a circular snap-action spring disc, on which the contact element is fastened centrally. In this case, the contact element is a movable contact part which is pressed by the snap-action spring disc against the first stationary counter contact, which is arranged internally on a cover of the housing of the known switch.

The snap-action spring disc presses with its rim against an inner base of a lower part of the housing, which acts as second counter contact.

In this way, the in itself electrically conductive snap-action spring disc produces an electrically conductive connection between the two counter contacts.

The external connection of the known switch is performed firstly via the outer side of the electrically conductive lower part and secondly by means of a via of the first stationary counter contact through the upper part onto the outer side thereof, where a solder terminal can be provided, for example.

The bi-stable snap-action disc is, in the case of the known switch, a bimetallic snap-action disc which flips over from its convex configuration to a concave configuration when its response temperature is exceeded.

The bimetallic snap-action disc has a central through-opening, by means of which it is arranged on the movable contact part which is fastened on the snap-action spring disc.

In its low-temperature position, the bimetallic snap-action disc lies loosely between the snap-action spring disc and the upper part of the housing. If the temperature of the bimetallic snap-action disc increases, it flips over into its high-temperature position, in which it presses with its rim against the inside on the upper part of the housing and in the process presses with its centre onto the snap-action spring disc in such a way that the latter flips from its first stable configuration to its second stable configuration, as a result of which the movable contact part is lifted off from the stationary counter contact and the switch is opened.

If the temperature of the switch cools down again, the bimetallic snap-action disc flips back into its low-temperature position. In the process, it comes to bear with its rim against the rim of the snap-action spring disc and with its centre against the upper part of the housing. The actuating force of the bimetallic snap-action disc is insufficient, however, for causing the snap-action spring disc to flip back into its first configuration.

Only by severe cooling down of the switch does the bimetallic snap-action disc bend back further so that it finally can press the rim of the snap-action spring disc so far against the inner base of the lower part that the snap-action spring disc flips back into its first configuration and closes the switch again.

Therefore, the known switch remains open once it has been opened until it has cooled down to a temperature below room temperature, for which purpose a coolant spray can be used, for example.

Although this switch in many application cases meets the corresponding safety requirements, it has nevertheless been found that, by virtue of the clamping of the bimetallic snap-action disc between the upper part of the housing and the rim of the snap-action spring disc, in some situations undesired flipping back of the snap-action spring disc nevertheless takes place.

In order to eliminate this problem, the actuating forces of the snap-action spring disc and the bimetallic snap-action disc need to be matched very precisely to one another, with the result that a particular choice of materials is required, which results in higher production costs for the known switch.

In order that the bimetallic snap-action disc can flip back from its high-temperature configuration to its low-temperature configuration, it rests only loosely on the movable contact part, with the result that it can lift off from said movable contact part upwards centrally.

For the assembly of the known switch, this means, however, that initially the snap-action spring disc with the contact part fastened thereto needs to be inserted into the lower part, whereupon the bimetallic snap-action disc then needs to be positioned centrally in the round lower part in such a way that it is pushed onto the contact part with its through-opening. Only then can the upper part be positioned on the lower part.

If the upper part and the lower part consist of an electrically conductive material, as is often desired for simple contact-making via the outer surfaces of the housing, previously an insulating film needs to be inserted between the upper part and the lower part. With these procedures, it is not always possible to prevent the bimetallic snap-action disc from shifting or displacing in the housing such that the switch is non-functional owing to the bimetallic snap-action disc being stuck.

This faulty assembly cannot be identified from the outside, however, with the result that only when the final check is completed in conclusion can it be established whether the switch has actually been correctly assembled. However, this cannot only be seen from the fact that the switch conducts electricity in its low-temperature position, but a check also needs to be performed to establish whether the switch is open in its high-temperature position. In other words, the operation of the bimetallic snap-action disc needs to be checked after complete assembly, which also includes cooling to a temperature below room temperature.

All this results in high manufacturing costs for the known temperature-dependent switch, wherein a certain amount of rejects is unavoidable.

In accordance with the above description, the known switch conducts the load current of the device to be protected via the snap-action spring disc, which is only possible up to a certain current intensity. At higher current intensities, the snap-action spring disc is heated to such an extent that this intrinsic Ohmic heating results in the switching temperature of the bimetallic snap-action disc being reached before the device to be protected has actually reached its impermissible temperature.

DE 26 44 411 A1 and, for example, DE 10 2011 016 142 A1 disclose using as contact element a current transfer element, for example in the form of a contact plate which is borne by the snap-action spring disc. Now, both stationary counter contacts are arranged on the inner side of the cover of the housing, wherein by the contact plate bearing against these two counter contacts, an electrically conductive connection between said counter contacts is produced.

In the case of this switch, the snap-action spring disc is fixed with its rim on the lower part of the housing, while the bimetallic snap-action disc is provided between the snap-action spring disc and the inner base of the lower part.

Below the response temperature of the bimetallic snap-action disc, the snap-action spring disc presses the contact plate against the two counter contacts. If the bimetallic snap-action disc flips into its high-temperature position, it presses with its rim against the snap-action spring disc and, with its centre, pulls the snap-action spring disc away from the upper part, with the result that the contact plate comes out of bearing contact with the two counter contacts. In order that this is geometrically possible, the contact plate, the snap-action spring disc and the bimetallic snap-action disc are connected to one another in a captive manner by a centrally running rivet.

If the temperature of the bimetallic snap-action disc decreases again, the snap-action spring disc presses the current transfer element against the two stationary counter contacts again.

Therefore, this switch does not have a self-holding function. However, it is known to provide such switches having a current transfer element with a self-holding resistor, but this does have the disadvantages mentioned at the outset.

DE 25 44 201 A1, mentioned at the outset, discloses a temperature-dependent switch comprising a current transfer element in the form of a contact bridge, in which the contact bridge is pressed via a closing spring against two stationary counter contacts.

The contact bridge is in contact with a temperature-dependent switching mechanism via an actuating bolt, which switching mechanism comprises a bimetallic snap-action disc and a snap-action spring disc.

As in the switch known from DE 10 2007 042 188 B3, the snap-action spring disc and the bimetallic snap-action disc are both bi-stable, with the bimetallic snap-action disc operating in temperature-dependent fashion and the snap-action spring disc operating in temperature-independent fashion.

If the temperature of the bimetallic snap-action disc increases, it presses the snap-action spring disc into its second configuration, in which it presses the actuating bolt against the contact bridge and in the process lifts said contact bridge off from the stationary counter contacts against to the force of the closing spring.

Even during cooling of the bimetallic snap-action disc, the snap-action spring disc remains in this second configuration and keeps the known switch open against to the force of the closing spring.

Pressure can now be exerted on the contact bridge by a button from outside, with the result that the snap-action spring disc is pressed back into its first stable configuration via the actuating bolt.

In addition to the very complex construction, this switch firstly has the disadvantage that, in the open state, the snap-action spring disc lifts off the contact bridge from the counter contacts against to the force of the closing spring, with the result that the snap-action spring disc in its second configuration needs to overcome the force of the closing spring. Owing to the fact that the closing spring in the closed state ensures that the contact bridge bears safely against the counter contacts, however, a snap-action spring disc with a very high degree of stability in the second configuration is required here.

A further disadvantage with the known switch consists in that the snap-action spring disc and the bimetallic snap-action disc are each arranged at their rim fixedly in a housing part of the switch. In the cooling position of the known switch, i.e. in the position in which the snap-action spring disc is again in its second configuration and the bimetallic snap-action disc is again in its low-temperature configuration, the bimetallic snap-action disc then presses with its rim onto the rim of the spring/snap-action disc. This weakens the actuating force which needs to be applied by the snap-action spring disc for keeping the contact bridge at a distance from the stationary counter contacts against the force of the closing spring.

In addition to high manufacturing costs, the known switch therefore has the further disadvantage that it closes again in an undesired manner.

A further switch with three switching positions is known from DE 86 25 999 U1 already mentioned above. In this known switch, a spring tongue is provided which is clamped in at one end and which bears a movable contact part at its free end, which movable contact part interacts with a fixed counter contact.

A dome is formed on this spring tongue, which dome is pressed into its second configuration by a bimetallic plate which is likewise fastened on the spring tongue, in which second configuration the movable contact part is spaced apart from the stationary counter contact.

The dome in the case of this switch needs to keep the movable contact part at a distance from the fixed counter contact against the closing force of the spring tongue which is clamped in at one end, with the result that the dome in its second configuration needs to apply a high actuating force.

The known switch therefore has the disadvantages already discussed above, namely that of having to overcome high actuating forces, which results in high manufacturing costs and in an unsafe state in the cooling position.

### SUMMARY OF THE INVENTION

In view of the above, it is among others an object of the present invention to improve the switch mentioned at the outset such that it is given a simple inexpensive design and nevertheless ensures safe interruption of the circuit even in the cooling position of the switch.

This and other objects are achieved according to the invention in that the snap-action disc is fixed on the contact element, and in that a clearance is provided for the rim of the snap-action disc, into which clearance the rim protrudes at least partially when the snap-action disc assumes its low-temperature configuration again while the spring disc is in its second configuration.

According to one object, the snap-action disc is fastened on the contact element, so that it can be arranged so to speak beneath the spring disc, with the result that it acts with its centre not on the spring disc but on the contact element and draws said contact element away from the stationary counter contact when it flips over from its low-temperature position to its high-temperature position. In the process, it carries along the spring disc as well via the contact element, with the result that said spring disc flips over into its second configuration, in which it keeps the switch permanently open.

If the snap-action disc now flips back into its low-temperature position, its rim enters the free space in which no abutment is provided for it, with the result that it cannot press back the spring disc into its first configuration again.

Even relatively severe cooling of the snap-action disc does not result here in the spring disc being pressed back into its first configuration again, in which it would close the switch again.

There is therefore also not the risk of the snap-action disc pressing the spring disc back into its first configuration in an undesired manner, as is possible in all of the switches mentioned at the outset.

According to another object, the snap-action disc and the spring disc are fixed on the contact element via their respective centre and preferably the snap-action disc and the spring disc are fixed in a captive manner on the contact element, such that the assembly of the novel switch is simple because first the switching mechanism comprising contact element, spring disc and snap-action disc can be fitted and then it can be inserted as a whole into the lower part of a housing.

According to a further object, the contact element comprises a movable contact part interacting with the first counter contact, and the spring disc interacts with the second counter contact, wherein, preferably, the spring disc, at least in its first configuration, is connected electrically over its rim to the second counter contact.

In principle, this configuration is already known from DE 10 2007 042 188 B3. This configuration results in the snap-action disc not being subjected to current loading in any position of the switch, but in the load current of the electrical device to be protected flowing through the spring disc.

According to another object, the contact element comprises a current transfer element which interacts with the two counter contacts.

It is advantageous here that the novel switch can conduct considerably higher currents than the switch known from DE 10 2007 042 188 B3. That is to say that, in the closed state of the switch, the contact element ensures the electrical short circuit between the two counter contacts, with the result that not only the snap-action disc but also the spring disc now no longer have load current flowing through them.

According to one object, the switch comprises a housing, on which the two counter contacts are provided and in which the switching mechanism is arranged.

This measure is known per se and ensures that the switching mechanism is protected from the ingress of dirt. The housing may be an individual housing of the switch or a pocket at the device to be protected from overheating.

In this case, it is particularly preferred when the spring disc is fixed with its rim at the housing.

If the contact element is a movable contact part, this measure has the advantage that the rim of the spring disc is always fixedly connected to the housing, with the result that a good electrical transfer resistance is provided there. The novel switch can therefore conduct higher currents than the switch known from DE 10 2007 042 188 B3, in which also the contact resistance to the lower part is determined by the contact pressure of the spring disc itself.

If a current transfer element is used as contact element, fixing the spring disc with its rim on the housing ensures that the contact element remains securely positioned with respect to the counter contacts.

According to one object, the housing has a lower part which is closed by an upper part, wherein the first counter contact or each of the two counter contacts is arranged on an inner side of the upper part.

This measure is known per se in design terms and, in the case of the novel switch, ensures that the geometrically correct assignment between the counter contact or the counter contacts and the respective contact element is also produced at the same time during fitting of the upper part on the lower part.

According to a further object, the lower part has an inner base, above the rim region of which the clearance is provided.

This measure is particularly advantageous in design terms since it makes it possible in a very simple manner to provide a temperature-dependent switch known per se with the three switching positions mentioned at the outset when in each case one bi-stable spring part with two configurations which are stable in temperature-independent fashion is used.

In the case of the switch known from DE 196 23 570 A1 comprising a movable contact part, this measure would by itself not yet result in the switch remaining open in the cooling position because the bimetallic snap-action disc is supported there with its rim on the outer rim of the base and would thus press the spring part back into its high-temperature position.

The same situation results in the switch known from DE 10 2011 016 142 A1, in which a spring disc which is clamped in fixedly on its rim and, beneath this, a snap-action disc are arranged beneath a current transfer element, which snap-action disc is supported with its rim likewise on the inside on the base of the lower part, with the result that, on cooling, it would press a bi-stable spring part back into its first configuration.

In order to avoid this, it would be necessary without the now additionally provided clearance, to design the actuating force of the spring disc in its second configuration to be so high that said spring disc cannot be pressed back into its first configuration by the snap-action disc.

The problems associated therewith have already been discussed in connection with DE 10 2007 042 188 B3.

In other words, in particular by virtue of the fact that the snap-action disc is arranged between the spring disc and the base of the lower part, but a clearance for the rim of the snap-action disc when in its cooling position is provided at the rim of the base, the novel switch cannot only be produced easily but also remains safely open in its cooling position.

Tests performed by the applicant have shown that even normal vibrations do not bring the novel switch back into its closing position; for this, extremely strong impacts on the base are required, which do not take place during conventional use of the novel switch.

Nevertheless, this opens up the possibility of bringing the novel switch back out of its cooling position into its low-temperature position when targeted strong impacts are exerted.

Therefore, this switch has a further advantage over the switch known from DE 25 44 201 A1 and the switch known from DE 86 25 999 U1. In said documents, additional re-setting elements are provided which pass in longitudinally displaceable fashion into the interior of the switch in order to enable the abovementioned re-setting of the switch.

The known switches therefore not only have the disadvantage that the re-setting forces of the spring discs need to be very high, but they also have the disadvantage that, owing to the re-setting element, not only the design is more complicated, but also the re-setting elements increase the risk of the ingress of dirt into the interior of the switch.

The novel switch can be embodied so as to be completely encapsulated, on the other hand.

In general, it is further preferred if the lower part is manufactured from an electrically conductive material and preferably the upper part is manufactured from an electrically insulating material, wherein the bi-stable snap-action disc can be a bimetallic or trimetallic snap-action disc.

Further advantages result from the description and the attached drawing.

It goes without saying that the features mentioned above and yet to be explained below can be applied not only in the respectively cited combination, but also in other combinations or on their own without departing from the scope of the present invention.

### BRIEF DESCRIPTION OF THE DRAWINGS

Embodiments of the invention are illustrated in the drawing and will be explained in more detail in the description below. In the drawing:

FIG. 1 shows a schematic illustration from the side of a first embodiment of the novel switch in its low-temperature position;

FIG. 2 shows an illustration as in FIG. 1, but in the high-temperature position of the novel switch;

FIG. 3 shows an illustration as in FIGS. 1 and 2, but in the cooling position of the novel switch;

FIG. 4 shows a schematic illustration from the side of a second embodiment of the novel switch in its low-temperature position;

FIG. 5 shows an illustration as in FIG. 4, but in the high-temperature position of the novel switch; and

FIG. 6 shows an illustration as in FIGS. 4 and 5 of the novel switch in its cooling position.

### DESCRIPTION OF PREFERRED EMBODIMENTS

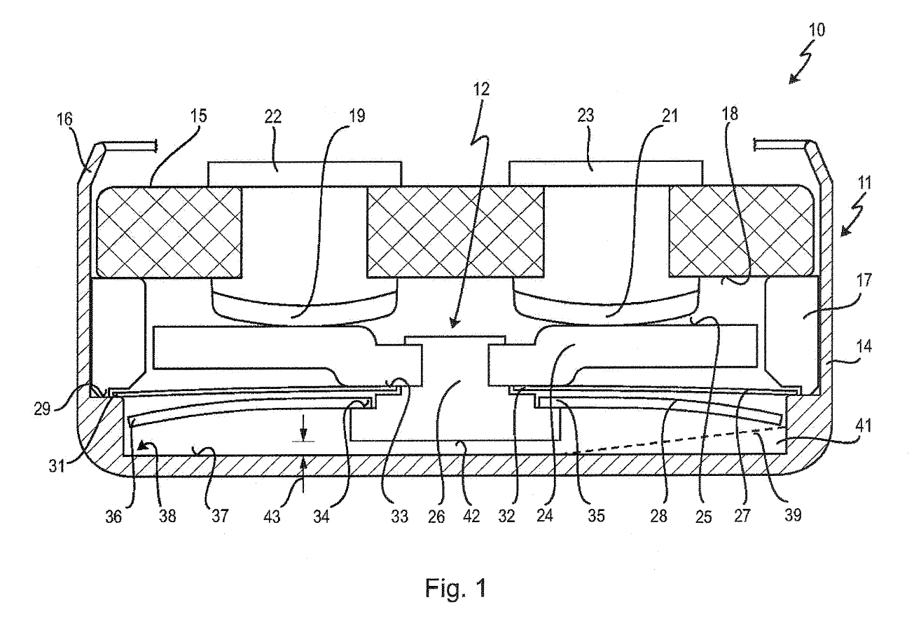

FIG. 1 shows a schematic, sectional side view of a switch 10 which is rotationally symmetrical in plan view, and preferably has a circular shape.

The switch 10 has a housing 11, in which a temperature-dependent switching mechanism 12 is provided.

The housing 11 comprises a pot-like lower part 14 consisting of an electrically conductive material and a flat, insulating upper part 15, which is held on the lower part 14 by a bent-back rim 16. For reasons of clarity, the bent-back rim 16 is not illustrated as crossing transversely over the upper part 15.

A spacer ring 17 which keeps spaced apart the upper part 15 from the lower part 14 is provided between the upper part 15 and the lower part 14.

The upper part 15 has an inner side 18, on which a first stationary counter contact 19 and a second stationary counter contact 21 are provided. The counter contacts 19 and 21 are in the form of rivets which extend through the upper part 15 and end on the outside in heads 22 and 23, respectively, which are used for the external connection of the switch.

The switching mechanism 12 comprises, as contact element, a current transfer element 24, which in the embodiment shown is a contact plate, whose upper side 25 is provided with an electrically conductive coating, with the result that in the bearing arrangement against the counter contacts 19 and 21 shown in FIG. 1, said contact plate ensures an electrically conductive connection between the two counter contacts 19 and 21.

The current transfer element 24 is connected to a bi-stable spring disc 27 and a bi-stable snap-action disc 28 via a rivet 26.

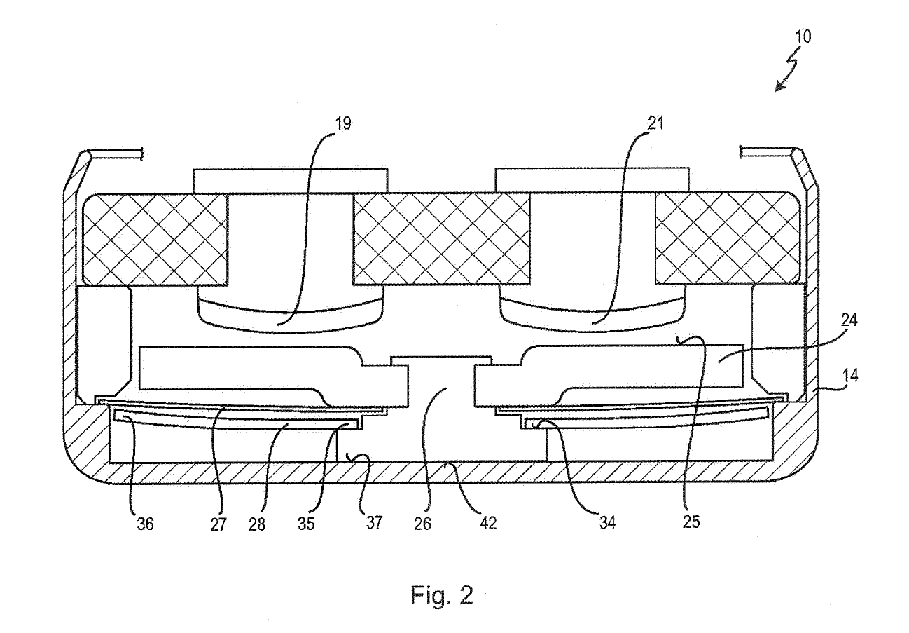

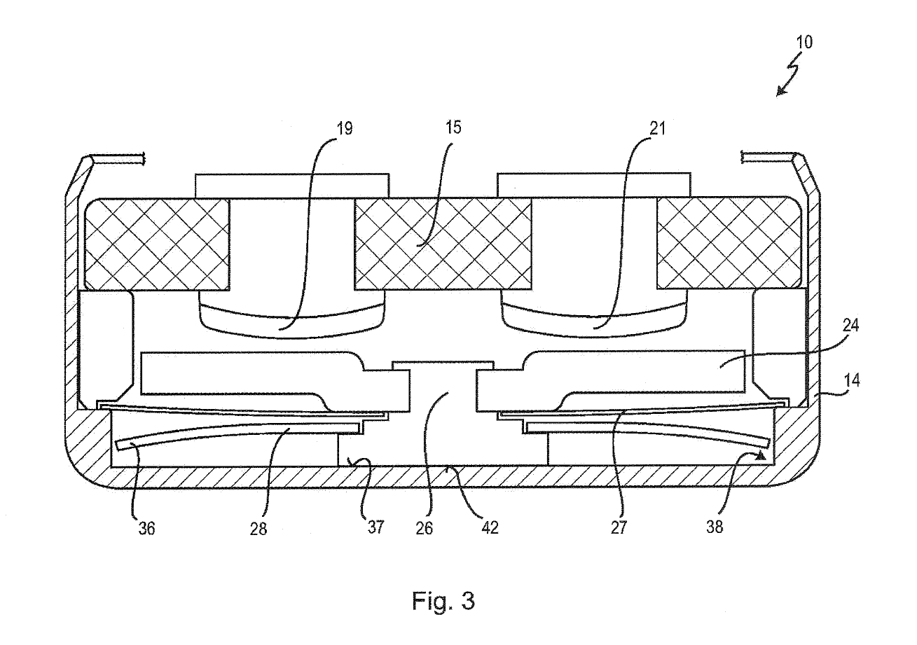

The spring disc 27 has two temperature-independent configurations, of which the first configuration is shown in FIG. 1 and the second configuration is shown in FIGS. 2 and 3.

The snap-action disc 28 has two temperature-dependent configurations, namely its low-temperature configuration which is shown in FIGS. 1 and 3 and its high-temperature configuration which is shown in FIG. 2.

A peripheral shoulder 29 is provided on the inside in the lower part 14, with said spacer ring 17 resting on said shoulder. The spring disc 27 is clamped in with its rim 31 between the shoulder 29 and the spacer ring 17, while it rests with its centre 32 on a shoulder 33 at the rivet 26. At its centre 32, the spring disc 27 is therefore clamped in between the current transfer element 24 and the shoulder 33.

In FIG. 1, another shoulder 34 is shown further down and further outwards radially on the rivet 26, with the snap-action disc 28 resting with its centre 35 on said shoulder.

The centre 35 rests freely on the shoulder 34.

The snap-action disc 28 lies with its rim 36 freely above an inner base 37 of the lower part 14.

A peripheral clearance 38 in the peripheral rim region 39 of the lower part 14 is provided beneath the rim 36.

A wedge 41, which in the case of the switch known from DE 10 2011 016 142 A1, acts as resting face for the rim 36, is illustrated on the right-hand side by dashed lines on the inner side 37 in FIG. 1.

The rivet 36 also has a base 42, which points towards the inner base 37 but has a distance (denoted by 43) with respect to said inner base 37 in the low-temperature position of the switch 10 shown in FIG. 1.

If the temperature of the snap-action disc 28 is now increased, its rim 36 in FIG. 1 lifts upwards, with the result that the snap-action disc 26 flips back from its convex position shown in FIG. 1 into its concave position shown in FIG. 2, in which its rim 36 is supported on a part of the switch 10, in this case on the spring disc 27, as can be seen from FIG. 2.

On the transition from its low-temperature configuration in FIG. 1 to its high-temperature configuration in FIG. 2, the snap-action disc 28 is therefore supported with its rim 37 on the spring disc 27, whereby it presses with its centre 35 onto the shoulder 34 of the rivet 26 and thereby presses the current transfer element 24 away from the stationary counter contacts 19 and 21 against to the force of the spring disc 27.

By virtue of this movement, the rivet 26 is set down with its base 42 on the inner base 37 of the lower part 14, wherein at the same time the spring disc 27 is snapped over from its first configuration shown in FIG. 1 into its likewise stable second geometric configuration shown in FIG. 2.

While the spring disc 27 in its first configuration as shown in FIG. 1 holds the current transfer element 24 in bearing contact with the counter contacts 19 and 21, in its second configuration shown in FIG. 2 it holds the current transfer element 24 at a distance from the counter contacts 19 and 21, with the result that the switch 10 is open.

While the switch 10 in FIG. 1 is in its closed low-temperature position, it is in its open high-temperature position in FIG. 2.

If the temperature of the device to be protected and therefore the temperature of the switch 10 is now cooled down again, the snap-action disc 28 snaps back from its high-temperature configuration shown in FIG. 2 to its low-temperature configuration again, which it had already assumed in FIG. 1.

The switch 10 is now located in its still open cooling position illustrated in FIG. 3.

It can be seen from FIG. 3 that the spring disc 27 is still in its second configuration, in which it holds the current transfer element 27 at a distance from the counter contacts 19 and 21, wherein the base 42 of the rivet 26 continues to rest on the inner base 37 of the lower part 14.

The snap-action disc 28 is again located in its low-temperature configuration to which it has been cooled down as a result of the cooling down of the device to be protected. The rim 36 of the snap-action disc 28 has moved downwards in FIG. 3 and is now in the clearance 38, i.e. does not have any contact with the lower part 14 or the base 37, with the result that the snap-action disc 28 is not able to press the spring disc 27 back into its first configuration, as would be the case for the switch according to DE 10 2011 016 142 A1, because in the known switch the wedge-shaped shoulder 41 indicated by dashed lines in FIG. 1 runs there instead of the clearance 38 that is provided according to invention.

In the cooling position shown in FIG. 3, the switch 10 remains even in the event of relatively strong impacts on the housing 11. Only a very strong impact from below on the lower part 14 in the region of the rivet 26 can result in the spring disc 27 snapping back into its first configuration again, with the result that the switch 10 is closed again, as shown in FIG. 1.

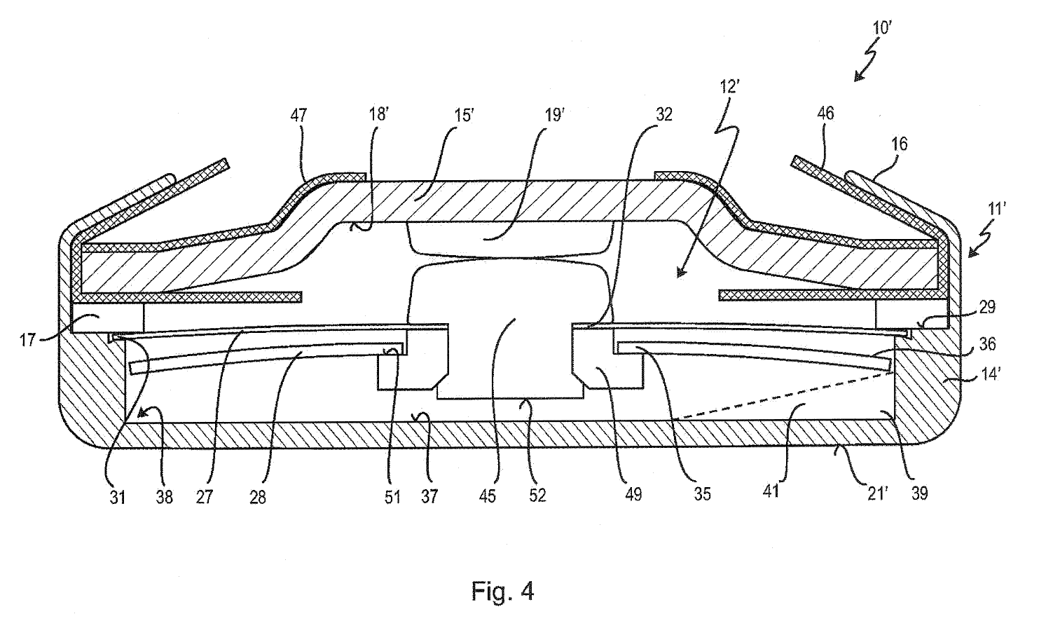

While FIGS. 1 to 3 show a first embodiment of the novel switch 10, in which a current transfer element 24 is used as contact element, FIGS. 4 to 6 show a second embodiment of the novel switch, in which a movable contact part 45 which is part of the switching mechanism 12′ is used as contact element.

The switch 10′ shown in FIG. 4 again has a pot-like lower part 14′, with a spacer ring 17 again resting on the peripheral shoulder 29 of said lower part, said spacer ring bearing the upper part 15′ with an insulation film 46 interposed.

The lower part 14′ and the upper part 15′ are in this case each manufactured from an electrically conductive material, with the result that contact with an electrical device to be protected can be produced via their outer faces. The outer faces are at the same time also used for the external electrical connection.

The upper part 15′ is again held on the lower part 14′ by the bent-back rim 16 thereof, wherein yet another insulation layer 47 is applied to the outside of the upper part 15′.

The switching mechanism 12′ in this case also comprises the spring disc 27 and the snap-action disc 28, wherein the spring disc 27 is clamped in with its rim 31 between the shoulder 29 and the spacer ring 17.

The spring disc 27 is fixed with its centre 32 on the contact part 45, for which purpose a ring 49 is pressed onto said contact part.

The ring 49 has a peripheral shoulder 51, on which the snap-action disc 28 rests with its centre 35.

In this way, the temperature-dependent switching mechanism 12′ shown in FIG. 4 is a unified set comprising contact element, spring disc 27 and snap-action disc 28 in the same way as the switching mechanism 12 shown in FIGS. 1 to 3.

During fitting of the switches 10 and 10′, the switching mechanism 12, 12′ can therefore be inserted into the lower part 14, 14′ directly as one unit.

The movable contact part 45 interacts with a fixed counter contact 19′, which is arranged on the inside on the upper part 15.

The outer side of the lower part 14′, which is manufactured from an electrically conductive material, is used as second counter contact 21′.

In the position shown in FIG. 4, the switch 12′ is in its low-temperature position, in which the spring disc 27 is in its first configuration and the snap-action disc 28 is in its low-temperature configuration.

In this case, the spring disc 27 presses the movable contact part 45 against the stationary counter contact 19′.

The movable contact part 45 has a base 52, which points towards the inner base 37 of the lower part 14′ and has a distance with respect thereto which is comparable to the distance 43 shown in FIG. 1.

Again, a peripheral clearance 38 is provided beneath the rim 36 of the snap-action disc 28 and is provided in the rim region 39 of the inner base 37.

The switch 10′ described to this extent has roughly the same geometric features as the switch from DE 196 23 570 A1 mentioned at the outset.

In this known switch, however, a wedge-shaped, peripheral shoulder 41 is located in the rim region 39, said shoulder having the same function as the peripheral shoulder 41 in the switch from DE 10 2011 016 142 which corresponds roughly geometrically speaking to the switch shown in FIGS. 1 to 3. This shoulder 41 is not provided for in the new switch 10′.

Since the spring disc 27 is clamped in with its rim 31 between the spacer ring 17 and the shoulder 29, it is electrically conductively connected to the lower part 14′ there with a very low transfer resistance.

At its centre 32, the spring disc 27 is clamped in between the movable contact part 45 and the ring 49, with the result that an electrically very low transfer resistance prevails there too.

In the closed low-temperature position of the switch 10′ shown in FIG. 4, an electrically conductive connection is thus produced between the counter contact 19′ and the counter contact 22′ via the movable contact part 45 and the spring disc 27.

In this case, the snap-action disc 28 rests freely on the shoulder 41 below the spring disc 27.

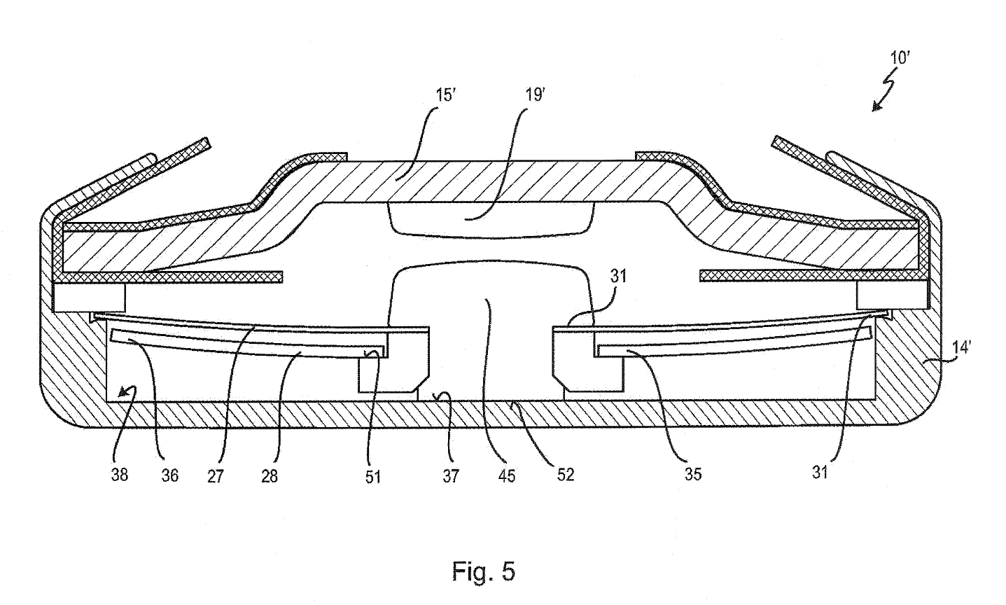

If the temperature of the device to be protected and thus the temperature of the snap-action disc 28 now increases, said snap-action disc snaps over from the convex low-temperature configuration shown in FIG. 4 to its concave high-temperature configuration shown in FIG. 5.

During this snap-over process, the snap-action disc 28 is supported with its rim 26 on a part of the switch 10′, in this case on the rim 31 of the spring disc 27.

The snap-action disc 28 in the process presses with its centre 35 on the shoulder 51 and thus lifts off the movable contact part 45 from the stationary contact part 19′.

As a result, the spring disc 27 at the same time bends downwards at its centre 32, with the result that the spring disc 27 snaps over from its first stable geometric configuration of FIG. 4 to its second stable geometric configuration of FIG. 5.

In this second configuration, the spring disc 27 presses the base 52 of the contact part 45 against the inner base 37 of the lower part 14′.

FIG. 5 therefore shows the high-temperature position of the switch 10′, in which said switch is open.

If the device to be protected and therefore the snap-action disc 28 now cool down again, the snap-action disc 28 snaps back into its low-temperature position, as shown in FIG. 4, for example. For this purpose, the rim 36 in FIG. 5 moves downwards and therefore into the clearance 38.

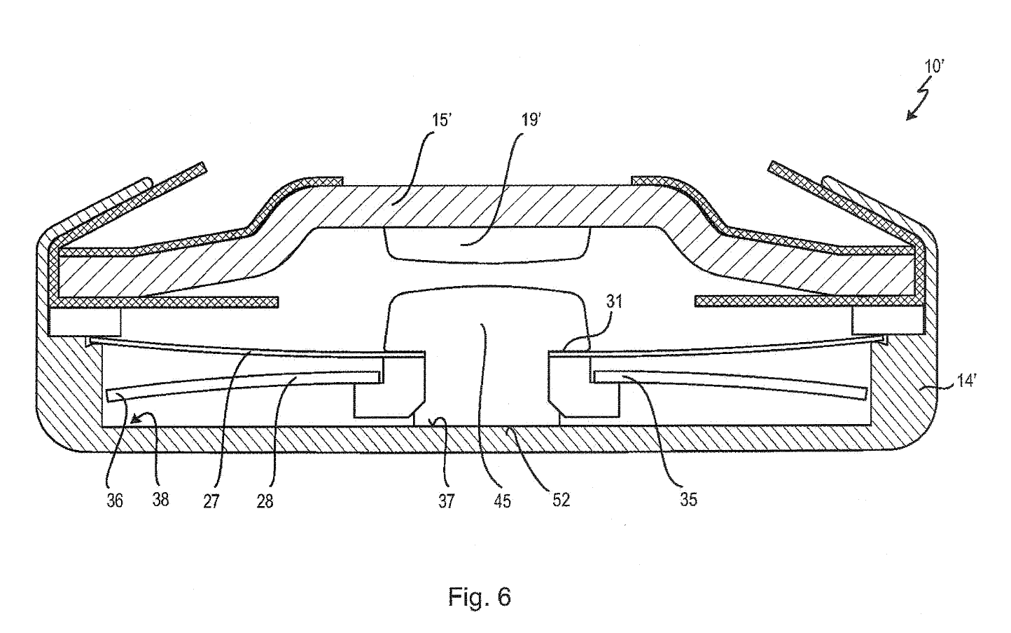

The switch 10′ is now in its cooling position shown in FIG. 6.

The spring disc 27 is still in its geometrically stable second configuration, in which it holds the contact part 45 at a distance from the counter contact 19′, whereby the contact part 45 rests with its base 52 on the inner base 37 of the lower part 14.

The snap-action disc 28 is again in its low-temperature configuration, wherein it has moved with its rim 36 into the clearance 38. The snap-action disc 28 is thus not capable of pressing the contact part 45 or the spring disc 27 upwards at its centre 32 in FIG. 6.

Therefore, what is claimed is:

1. A temperature-dependent switch comprising:
a first and a second stationary counter contact and a temperature-dependent switching mechanism, said switching mechanism comprising a contact element, a temperature-dependent snap-action disc with a geometric high-temperature configuration and a geometric low-temperature configuration and a bi-stable spring disc with two geometric configurations with temperature-independent stability, said spring disc bearing the contact element,
wherein said switching mechanism comprises at least two switching positions, and in one of its switching positions produces an electrically conductive connection between the two counter contacts via the contact element,
wherein the spring disc in its first configuration presses the contact element against the first counter contact and in its second configuration keeps the contact element spaced apart from the first counter contact,
wherein the snap-action disc is supported with its rim on a part of the switch during the transition of the snap-action disc from its low-temperature configuration into its high-temperature configuration and in the process acts on the spring disc in such a way that said spring disc flips from its first configuration into its second stable configuration, in which second stable configuration it remains even when the snap-action disc flips back from its high-temperature configuration into its low-temperature configuration,
wherein the snap-action disc is fixed on the contact element, and
wherein a clearance is provided for the rim of the snap-action disc, into which clearance the rim protrudes at least partially when the snap-action disc assumes its low-temperature configuration while the spring disc is in its second configuration.

2. The switch of claim 1, wherein the snap-action disc and the spring disc are fixed on the contact element via their respective center.

3. The switch of claim 1, wherein the snap-action disc and the spring disc are fixed in a captive manner on the contact element.

4. The switch of claims 1, wherein the contact element comprises a movable contact part interacting with the first counter contact, and the spring disc interacts with the second counter contact.

5. The switch of claim 4, wherein the spring disc, at least in its first configuration, is connected electrically over its rim to the second counter contact.

6. The switch of claims 1, wherein the contact element comprises a current transfer element which interacts with the two counter contacts.

7. The switch of claims 1, which comprises a housing, on which housing the two counter contacts are provided and in which housing the switching mechanism is arranged.

8. The switch of claim 7, wherein the spring disc is fixed with its rim at the housing.

9. The switch of claim 7, wherein the housing has a lower part which is closed by an upper part, wherein at least the first counter contact is arranged on an inner side of the upper part.

10. The switch of claim 9, wherein said first and second contact are arranged on said inner side of the upper part.

11. The switch of claim 7, wherein the lower part has an inner base having a rim region, the clearance being provided above said rim region.

12. The switch of claim 7, wherein the lower part is manufactured from an electrically conductive material.

13. The switch of claim 7, wherein the upper part is manufactured from an electrically insulating material.

14. The switch of claim 1, wherein the bi-stable snap-action disc is a bimetallic snap-action disc.

15. The switch of claim 1, wherein the bi-stable snap-action disc is a trimetallic snap-action disc.

16. A temperature-dependent switch comprising:
a housing, a first and a second stationary counter contact provided on said housing, and a temperature-dependent switching mechanism arranged in said housing, said switching mechanism comprising a contact element, a temperature-dependent snap-action disc with a geometric high-temperature configuration and a geometric low-temperature configuration and a bi-stable spring disc with two geometric configurations with temperature-independent stability, said spring disc bearing the contact element,
wherein said switching mechanism comprises at least two switching positions, and in one of its switching positions produces an electrically conductive connection between the two counter contacts via the contact element,
wherein the spring disc in its first configuration presses the contact element against the first counter contact and in its second configuration keeps the contact element spaced apart from the first counter contact,
wherein the snap-action disc is supported with its rim on a part of the switch during the transition of the snap-action disc from its low-temperature configuration into its high-temperature configuration and in the process acts on the spring disc in such a way that said spring disc flips from its first configuration into its second stable configuration, in which second stable configuration it remains even when the snap-action disc flips back from its high-temperature configuration into its low-temperature configuration,
wherein the snap-action disc is fixed on the contact element, and
wherein a clearance is provided for the rim of the snap-action disc, in which clearance the rim is located when the snap-action disc is in its low-temperature configuration while the spring disc is in its second configuration.

17. A temperature-dependent switch comprising:
a housing having an inner base with a rim region, a first and a second stationary counter contact provided on said housing, and a temperature-dependent switching mechanism arranged in said housing, said switching mechanism comprising a contact element, a temperature-dependent snap-action disc with a geometric high-temperature configuration and a geometric low-temperature configuration and a bi-stable spring disc with two geometric configurations with temperature-independent stability, said spring disc bearing the contact element,
wherein said switching mechanism comprises at least two switching positions, and in one of its switching positions produces an electrically conductive connection between the two counter contacts via the contact element,
wherein the spring disc in its first configuration presses the contact element against the first counter contact and in its second configuration keeps the contact element spaced apart from the first counter contact,
wherein the snap-action disc is supported with its rim on a part of the switch during the transition of the snap-action disc from its low-temperature configuration into its high-temperature configuration and in the process acts on the spring disc in such a way that said spring disc flips from its first configuration into its second stable configuration, in which second stable configuration it remains even when the snap-action disc flips back from its high-temperature configuration into its low-temperature configuration,
wherein the snap-action disc is fixed on the contact element, and
wherein a clearance is provided above said rim region of said inner base to accommodate said rim of the snap-action disc, when the snap-action disc is its low-temperature configuration while the spring disc is in its second configuration.
